(19) United States
(12) Patent Application Publication
(10) Pub. No.: US 2020/0332577 A1
(43) Pub. Date: Oct. 22, 2020

(54) MAGNETIC LOCK STRUCTURE WITH LARGE ANTI-PULLING AREA

(71) Applicant: Soyal Technology Co., Ltd., New Taipei City (TW)

(72) Inventor: Hung-Kun SHIH, New Taipei City (TW)

(73) Assignee: Soyal Technology Co., Ltd., New Taipei City (TW)

(21) Appl. No.: 16/828,931

(22) Filed: Mar. 24, 2020

(30) Foreign Application Priority Data
Apr. 17, 2019 (TW) 108113434

(51) Int. Cl. E05C 19/16

(52) U.S. Cl. CPC E05C 19/166; E05C 19/165

(57) ABSTRACT

A magnetic lock structure with a large anti-pulling area includes a housing and an electromagnetic body received in a receiving space of the housing. The inner wall of the housing is provided with at least one first sliding portion. The outer wall of the electromagnetic body is provided with at least one second sliding portion. Once the electromagnetic body is pushed into the receiving space through an end of the housing, the second sliding portion abuts against the first sliding portion slidably to create a relatively large area of contact between the housing and the electromagnetic body. When the magnetic lock structure is in operation, the pulling force acting on the housing through the electromagnetic body is distributed evenly along the sliding portions to prevent deformation of the housing and prolong the service life of the magnetic lock structure.

### CROSS-REFERENCE TO RELATED PATENT APPLICATION

This non-provisional application claims priority to and the benefit of, under 35 U.S.C. § 119(a), Taiwan Patent Application No. 108113434, filed in Taiwan on Apr. 17, 2019. The entire content of the above identified application is incorporated herein by reference.

### FIELD

The present disclosure relates to a magnetic lock, and more particularly to a magnetic lock whose housing and electromagnetic body have sliding portions corresponding to each other and forming a large anti-pulling area.

### BACKGROUND

Doors, windows, cabinets, and so on are generally provided with locking devices to prevent unauthorized access and thereby ensure the safety of personal property. A sheerly mechanical lock can be cracked with tools (e.g., a master key) relatively easily. Electronic locks such as magnetic locks, keycard locks, electronic code locks, and wireless remote-controlled locks are gradually adopted for enhanced safety.

A magnetic lock, or electromagnetic lock to be exact, works on the principle of electrically induced magnetism. When supplied with electricity, a magnetic lock (e.g., one provided on a door frame) can attract and hold a mating armature plate (e.g., one provided on the door in the aforesaid door frame) and thus enter the locked state. When the power supply is cut off, the magnetic lock can no longer attract and hold the armature plate and is therefore in the unlocked state. Due to the lack of a complicated mechanical structure and a lock tongue, magnetic locks are suitable for use on emergency exit doors or fire doors for access control.

Referring to FIG. 1, a conventional magnetic lock 1 is typically composed of a housing 11 and an electromagnetic body 12. The housing 11 has a generally U-shaped cross section and forms a receiving space 110 therein. The electromagnetic body 12 at least includes an iron core and a coil. The iron core can be formed by welding together a plurality of silicon steel plates that are contiguously arranged, and the coil is wound around the iron core. When the electromagnetic body 12 is supplied with electricity, a magnetic attraction force is generated on its outer surface.

The conventional magnetic lock 1, however, still has some disadvantages in use.

First, with continued reference to FIG. 1, the electromagnetic body 12 and the housing 11 are locked to each other by a plurality of screws 13. When the magnetic lock 1 is in the locked state, the magnetic attraction force between the electromagnetic body 12 and the mating armature plate can be viewed as a pulling force that tends to pull the electromagnetic body 12 outward, i.e., out of the housing 11. This pulling force acts mainly on the contact points between the screws 13 and the screw holes 120 and 111 in the electromagnetic body 12 and the housing 11. The housing 11 is usually an extruded aluminum housing, whose structural strength is relatively low. Therefore, a relatively large force acting on the aforesaid contact points is very likely to deform the housing 11 in the contact point areas. The deformation can lead to a gap formed between the electromagnetic body 12 and the armature plate, which reduces the magnetic attraction force between the magnetic lock 1 and the armature plate.

Second, if the silicon steel plates are welded together to form the iron core, the magnetic permeability of the welded silicon steel plates will have been impaired. Therefore, the silicon steel plates will exhibit increased magnetic reluctance and reduced magnetism, which in turn lead to a low magnetic attraction force.

The issue to be addressed by the present disclosure is to provide an effective solution to the foregoing problems of the conventional magnetic locks so as to bring about better user experience.

### SUMMARY

In response to the above-referenced technical inadequacies associated with conventional magnetic locks, the present disclosure has culminated in the conception and development of a magnetic lock with large anti-pulling area. The present disclosure manifests years of practical experience in designing, processing, which, combined with long hours of research and experimentation, leads to such conception and development. The present disclosure is with the aim of overcoming the above-referenced technical inadequacies.

One aspect of the present disclosure is directed to a magnetic lock structure that has a large anti-pulling area. The magnetic lock structure includes a housing and an electromagnetic body. The housing is provided with a receiving space therein. The electromagnetic body is configured to be assembled within the receiving space of the housing, to receive externally supplied electricity, and to generate a magnetic attraction force on an exposed surface of the electromagnetic body. The housing has an inner wall provided with at least one first sliding portion. The electromagnetic body has an outer wall provided with at least one second sliding portion. Once the electromagnetic body is pushed into the receiving space through an end of the housing, the second sliding portion abuts against the first sliding portion slidably to form an area of contact between the first sliding portion and the second sliding portion that is relatively large. Thus, when the magnetic lock structure is in operation, the pulling force that is generated by and acts on the electromagnetic body and is applied by the electromagnetic body to the housing will be distributed evenly along the sliding portions. This protects the housing from deformation by excessive localized force application so that the service life of the magnetic lock structure will not be cut short.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The present disclosure will become more fully understood from the following detailed description and accompanying drawings.

FIG. 1 is an exploded perspective view of a conventional magnetic lock.

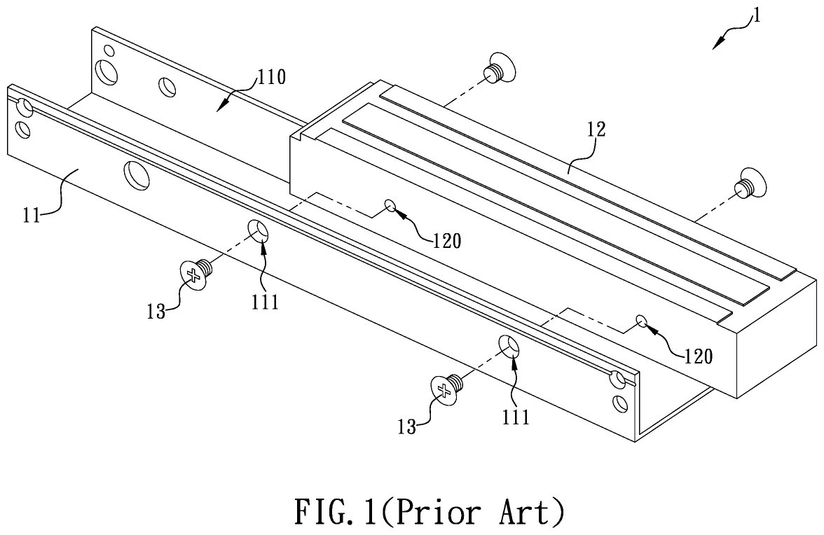

FIG. 2 is an exploded perspective view of a magnetic lock structure according to certain embodiments of the present disclosure.

FIG. 3 is an assembled perspective view of the magnetic lock structure according to certain embodiments of the present disclosure.

FIG. 4 schematically shows an iron core according to certain embodiments of the present disclosure.

FIG. 5 is an exploded perspective partial view of the magnetic lock structure according to certain embodiments of the present disclosure.

FIG. 6 schematically shows the magnetic lock structure according to certain embodiments of the present disclosure.

### DETAILED DESCRIPTION

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, parts or the like, which are for distinguishing one component/parts from another one only, and are not intended to, nor should be construed to impose any substantive limitations on the components, parts or the like.

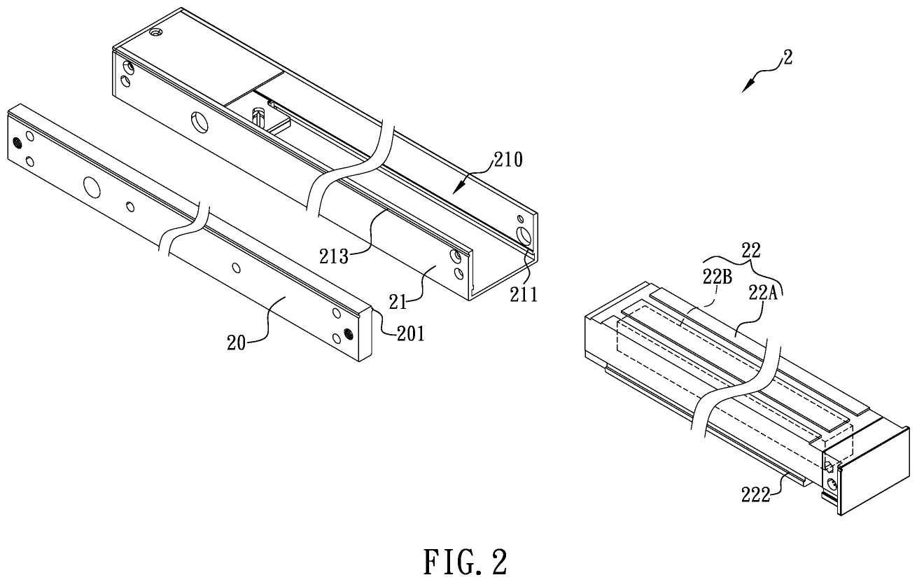

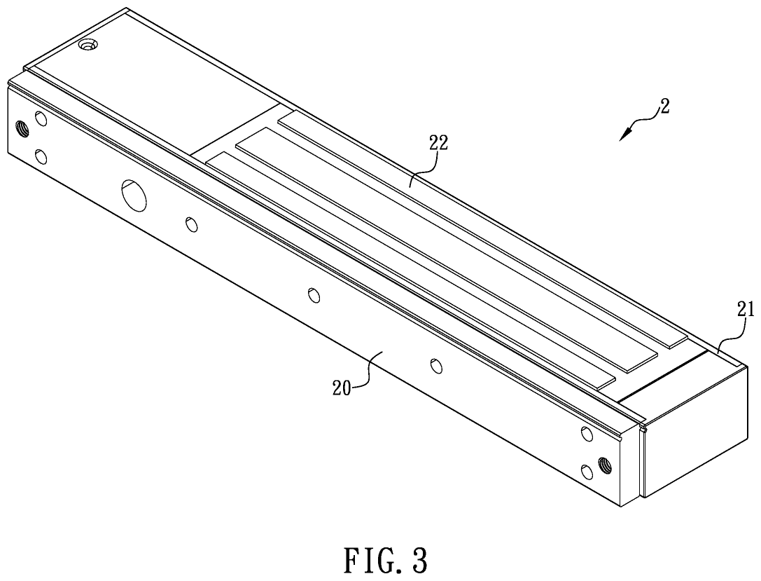

In certain embodiments, a magnetic lock structure 2 has a large anti-pulling area. Referring to FIG. 2 and FIG. 3, in certain embodiments, the magnetic lock structure 2 includes a housing 21 and an electromagnetic body 22. The housing 21 has a generally U-shaped cross section and is provided therein with a receiving space 210. The electromagnetic body 22 is configured to be assembled into the receiving space 210 of the housing 21 through an end of the housing 21, to receive externally supplied electricity, and to generate a magnetic attraction force on its exposed surface (e.g., the top surface as shown in FIG. 2). In certain embodiments, the electromagnetic body 22 includes an iron core 22A and a coil 22B. In certain embodiments, the iron core 22A may have an E-shaped cross section, and in that case, the coil 22B may be wound around the middle post of the iron core 22A either directly or indirectly (e.g., through a coil holder). In other embodiments, the components of the electromagnetic body 22 and their configurations can be adjusted according to product requirements.

With continued reference to FIG. 2 and FIG. 3, the magnetic lock structure 2 further includes a positioning portion 20. The positioning portion 20 is configured to be fixed on an external object (e.g., a door frame), and a lateral side of the housing 21 can be mounted to a lateral side of the positioning portion 20. In practical use, an armature plate is mounted on the door to whose door frame the positioning portion 20 is fixed, i.e., on whose door frame the housing 21 and the electromagnetic body 22 are mounted. When the magnetic lock structure 2 is supplied with electricity and enters the locked state by attracting and holding the armature plate on the door, the door cannot be opened. When the supply of electricity is cut off, the magnetic lock structure 2 enters the unlocked state, in which the magnetic lock structure 2 can no longer attract and hold the armature plate and therefore allows the door to be opened. In other embodiments, the positioning portion 20 may be dispensed with to meet product requirements. In that case, the housing 21 will be configured to be fixed directly to an external object (e.g., a door frame).

Referring again to FIG. 2 and FIG. 3, the inner wall of the housing 21 is provided with at least one first sliding portion 211, and the outer wall of the electromagnetic body 22 is provided with at least one second sliding portion 222. In certain embodiments, both the first sliding portion 211 and the second sliding portion 222 are configured as projecting rails. After the electromagnetic body 22 is pushed into the receiving space 210 through an end of the housing 21, the second sliding portion 222 abuts against the first sliding portion 211 slidably. For example, the top side of the second sliding portion 222 (i.e., the top side of the projecting rail 222) is in contact with the bottom side of the first sliding portion 211 (i.e., the bottom side of the projecting rail 211). Thus, the contact portions between the housing 21 and the electromagnetic body 22 provide an anti-pulling area larger than that provided by the contact points between a conventional magnetic lock and its screws. In other words, the conventional point contact is now improved into surface contact. When the magnetic lock structure 2 is supplied with electricity and attracts and thereby holds the mating armature plate, the force generated by the electromagnetic body 22 and tending to pull the electromagnetic body 22 outward (i.e., out of the housing 21) is distributed evenly over the contact area between the first sliding portion 211 and the second sliding portion 222. Therefore, uniform stress is produced, so the housing 21 will not be subjected to, let alone deformed by, an exceedingly large localized force. As a result, the magnetic attraction force between the magnetic lock structure 2 and the armature plate is effectively kept from changing, and the service life of the magnetic lock structure 2 is prolonged. In addition, the electromagnetic body 22, which only needs to be pushed into the housing 21 during assembly, can be mounted and detached more easily than its counterpart in a conventional magnetic lock.

As stated above and shown in FIG. 2, each of the first sliding portion 211 and the second sliding portion 222 is configured as a projecting rail. In certain embodiments, the first sliding portion 211 and the second sliding portion 222 may instead be a projecting rail and a groove respectively, or vice versa. The first sliding portion 211 and the second sliding portion 222 can be in any of these configurations provided that the housing 21 and the electromagnetic body 22 can be put together through a relative sliding motion enabled by the sliding portions 211 and 222, and are provided with a large anti-pulling area by the sliding portions 211 and 222.

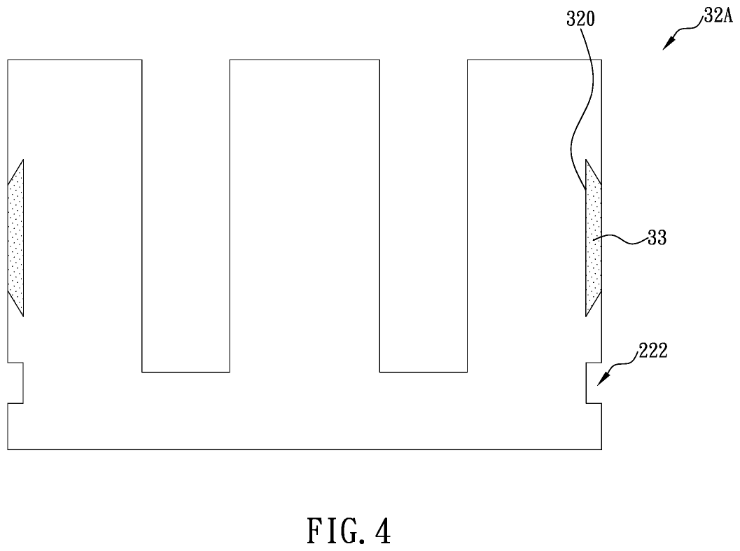

Moreover, with continued reference to FIG. 2, the iron core 22A may be formed by welding together a plurality of silicon steel plates that are contiguously arranged, just as in the case of a conventional magnetic lock. Or, referring to FIG. 4, the iron core 32A may include a plurality of silicon steel plates and at least one fixing bar 33. The silicon steel plates are stacked upon each other to combine into a strip structure without being welded together. Rather, at least one side of the iron core 32A is formed with an engaging groove 320 (the iron core 32A in FIG. 4 has one engaging groove 320 on each of two opposite sides respectively, and as shown in FIG. 4, a width of an open top end of the engaging groove 320 can be smaller than a width of a closed bottom end of the engaging groove 320 that is opposite to the open top end). The fixing bar 33 can be inserted into and mounted in the engaging groove 320 to connect the silicon steel plates together and thereby complete the iron core 32A. Since the silicon steel plates are not welded, their magnetic permeability is left intact. If the fixing bar 33 is made of a metal of high magnetic permeability, the magnetic field lines of the iron core 32A will be increased to enable stronger magnetic attraction.

Further, to effectively simplify the manufacturing process and lower the number of the components, in certain embodiments, a lateral edge of each of the silicon steel plates can be formed with a groove. After the silicon steel plates are stacked upon each other to combine into the iron core 32A, the grooves can form the second sliding portion 222 that is configured collectively as a groove. Further, after the iron core 32A is placed in the housing 21, this second sliding portion 222 can be engaged with the first sliding portion 211 in the housing 21. Therefore, the iron core 32A (that is, the silicon steel plates) can be placed stably in the housing 21. That is, the effect produced by this configuration of the first sliding portion 211 and second sliding portion 222 is the same as that by the engaging groove 320 and the fixing bar 33, so that the iron core 32A needs not undergo a welding process. It is further worth mentioning that when the iron core 32A forms the electromagnetic body 22 and is placed into the housing 21, it cannot be removed from the two lateral sides of the housing 21. Further, the movement of the iron core 32A is limited by the projecting-rail configuration of the first sliding portion 211, which also prevents the iron core 32A (that is, the silicon steel plates) from being removed from, and along a direction towards, the top surface of the housing 21.

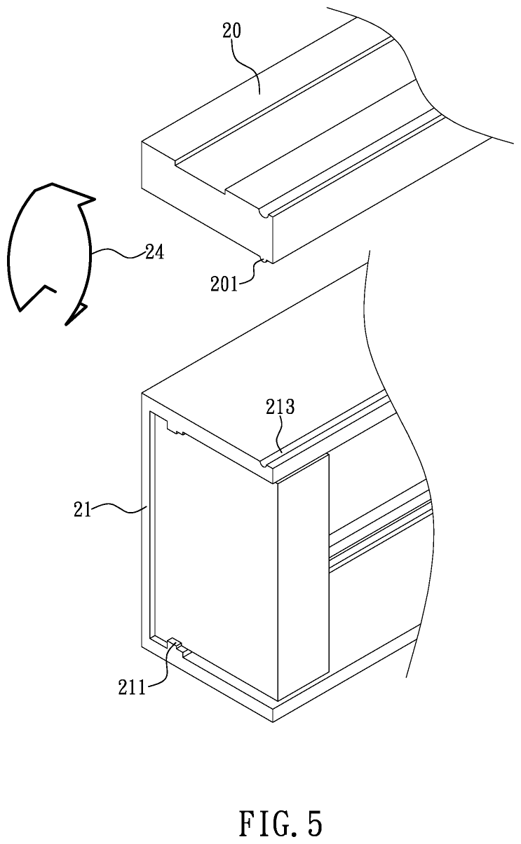

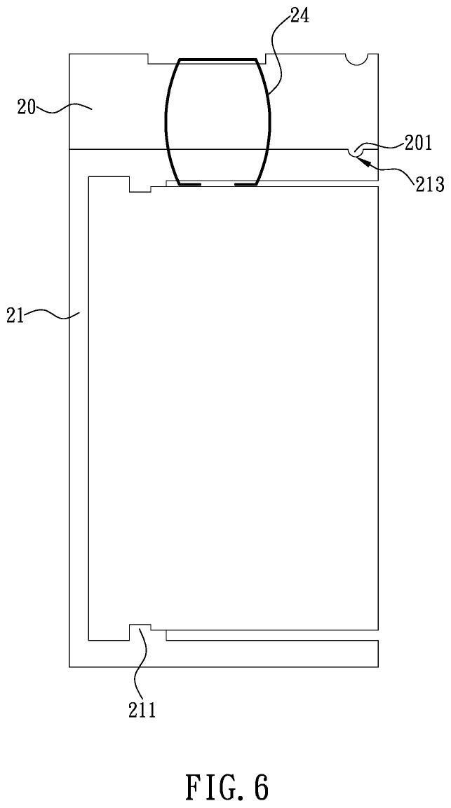

Furthermore, to enhance the ease and safety of installation of the magnetic lock structure 2, referring to FIG. 5 and FIG. 6 in conjunction with FIG. 2, in certain embodiments, the magnetic lock structure 2 further includes a plurality of clamps 24 (FIG. 5 shows only one of the clamps 24). Each clamp 24 can be formed by twisting a steel wire so as to be resilient. Once the housing 21 and the positioning portion 20 are put together, each of two opposite ends of the resulting assembly of the housing 21 and the positioning portion 20 is mounted with at least one of the clamps 24. Therefore, each clamp 24 can clamp together the adjacent end edges of the housing 21 and the positioning portion 20, as shown in FIG. 6. Thus, even if the locking screws between the housing 21 and the positioning portion 20 get loose, the clamps 24 will keep the housing 21 from falling off. In addition, to make it easier to mount the housing 21 to, and position the housing 21 accurately with respect to, the positioning portion 20, the aforesaid lateral side of the housing 21 may be concavely provided with a channel 213, and the aforesaid lateral side of the positioning portion 20 may be protrudingly provided with a ridge 201. After the housing 21 and the positioning portion 20 are mounted to each other, the ridge 201 is fitted in the channel 213 to not only ensure that the housing 21 is at the predetermined position, but also prevent the housing 21 from moving away from the predetermined position while the housing 21 is being locked with screws. The channel 213 and the ridge 201, therefore, also help reduce the risk of the housing 21 falling off during installation, or after long-term use, of the magnetic lock structure 2.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A magnetic lock structure, comprising:
a housing provided with a receiving space therein; and
an electromagnetic body configured to be assembled within the receiving space of the housing, to receive externally supplied electricity, and to generate a magnetic attraction force on an exposed surface of the electromagnetic body,
wherein the housing has an inner wall provided with at least one first sliding portion, the electromagnetic body has an outer wall provided with at least one second sliding portion, and once the electromagnetic body is pushed into the receiving space through an end of the housing, the second sliding portion abuts against the first sliding portion slidably to form an area of contact between the first sliding portion and the second sliding portion.

2. The magnetic lock structure according to claim 1, wherein each of the first sliding portion and the second sliding portion is a projecting rail.

3. The magnetic lock structure according to claim 1, wherein the first sliding portion is a projecting rail, and the second sliding portion is a groove.

4. The magnetic lock structure according to claim 1, wherein the first sliding portion is a groove, and the second sliding portion is a projecting rail.

5. The magnetic lock structure according to claim 1, wherein the electromagnetic body comprises an iron core, the iron core comprises a plurality of silicon steel plates and at least one fixing bar, the silicon steel plates are stacked upon each other to combine into a strip structure, the iron core is formed with an engaging groove on at least one side thereof, a width of an open top end of the engaging groove is smaller than a width of a closed bottom end of the engaging groove that is opposite to the open top end, and the fixing bar is configured to be inserted into and mounted in the engaging groove to connect the silicon steel plates together.

6. The magnetic lock structure according to claim 2, wherein the electromagnetic body comprises an iron core, the iron core comprises a plurality of silicon steel plates and at least one fixing bar, the silicon steel plates are stacked upon each other to combine into a strip structure, the iron core is formed with an engaging groove on at least one side thereof, a width of an open top end of the engaging groove is smaller than a width of a closed bottom end of the engaging groove that is opposite to the open top end, and the fixing bar is configured to be inserted into and mounted in the engaging groove to connect the silicon steel plates together.

7. The magnetic lock structure according to claim 3, wherein the electromagnetic body comprises an iron core, the iron core comprises a plurality of silicon steel plates and at least one fixing bar, the silicon steel plates are stacked upon each other to combine into a strip structure, the iron core is formed with an engaging groove on at least one side thereof, a width of an open top end of the engaging groove is smaller than a width of a closed bottom end of the engaging groove that is opposite to the open top end, and the fixing bar is configured to be inserted into and mounted in the engaging groove to connect the silicon steel plates together.

8. The magnetic lock structure according to claim 4, wherein the electromagnetic body comprises an iron core, the iron core comprises a plurality of silicon steel plates and at least one fixing bar, the silicon steel plates are stacked upon each other to combine into a strip structure, the iron core is formed with an engaging groove on at least one side thereof, a width of an open top end of the engaging groove is smaller than a width of a closed bottom end of the engaging groove that is opposite to the open top end, and the fixing bar is configured to be inserted into and mounted in the engaging groove to connect the silicon steel plates together.

9. The magnetic lock structure according to claim 5, further comprising a positioning portion configured to be fixed on an external object and has a lateral side configured to be mounted to a lateral side of the housing.

10. The magnetic lock structure according to claim 6, further comprising a positioning portion configured to be fixed on an external object and has a lateral side configured to be mounted to a lateral side of the housing.

11. The magnetic lock structure according to claim 7, further comprising a positioning portion configured to be fixed on an external object and has a lateral side configured to be mounted to a lateral side of the housing.

12. The magnetic lock structure according to claim 8, further comprising a positioning portion configured to be fixed on an external object and has a lateral side configured to be mounted to a lateral side of the housing.

13. The magnetic lock structure according to claim 9, further comprising a plurality of clamps, each configured to be mounted at one of two opposite ends of an assembly of the housing and the positioning portion formed by the housing and the positioning portion being mounted to each other, and to clamp together an end edge of the housing of the assembly and an adjacent end edge of the positioning portion of the assembly.

14. The magnetic lock structure according to claim 10, further comprising a plurality of clamps, each configured to be mounted at one of two opposite ends of an assembly of the housing and the positioning portion formed by the housing and the positioning portion being mounted to each other, and to clamp together an end edge of the housing of the assembly and an adjacent end edge of the positioning portion of the assembly.

15. The magnetic lock structure according to claim 11, further comprising a plurality of clamps, each configured to be mounted at one of two opposite ends of an assembly of the housing and the positioning portion formed by the housing and the positioning portion being mounted to each other, and to clamp together an end edge of the housing of the assembly and an adjacent end edge of the positioning portion of the assembly.

16. The magnetic lock structure according to claim 12, further comprising a plurality of clamps, each configured to be mounted at one of two opposite ends of an assembly of the housing and the positioning portion formed by the housing and the positioning portion being mounted to each other, and to clamp together an end edge of the housing of the assembly and an adjacent end edge of the positioning portion of the assembly.

17. The magnetic lock structure according to claim 13, wherein the lateral side of the housing is concavely provided with a channel, and the lateral side of the positioning portion is protrudingly provided with a ridge configured to be fitted in the channel when the housing and the positioning portion are mounted to each other.

18. The magnetic lock structure according to claim 14, wherein the lateral side of the housing is concavely provided with a channel, and the lateral side of the positioning portion is protrudingly provided with a ridge configured to be fitted in the channel when the housing and the positioning portion are mounted to each other.

19. The magnetic lock structure according to claim 15, wherein the lateral side of the housing is concavely provided with a channel, and the lateral side of the positioning portion is protrudingly provided with a ridge configured to be fitted in the channel when the housing and the positioning portion are mounted to each other.

20. The magnetic lock structure according to claim 16, wherein the lateral side of the housing is concavely provided with a channel, and the lateral side of the positioning portion is protrudingly provided with a ridge configured to be fitted in the channel when the housing and the positioning portion are mounted to each other.
